(19) United States
(12) Patent Application Publication
(10) Pub. No.: US 2025/0073954 A1
(43) Pub. Date: Mar. 6, 2025

(54) TOOL FOR MACHINING CMC SEGMENTS

(71) Applicant: Rolls-Royce High Temperature Composites, Inc., Cypress, CA (US)

(72) Inventor: Christopher James Downie, Cypress, CA (US)

(21) Appl. No.: 18/815,578

(22) Filed: Aug. 26, 2024

Related U.S. Application Data
(60) Provisional application No. 63/580,037, filed on Sep. 1, 2023.

(51) Int. Cl. B28D 1/22; B28D 7/02

(52) U.S. Cl. CPC B28D 1/22; B28D 7/02

(57) ABSTRACT

A machining system includes a blade assembly, a first shaft configured to rotate in a first direction, and a second shaft configured to rotate in a second direction that is opposite the first direction. The blade assembly includes a blade, a circular aperture, and an ovular aperture. The first shaft includes a first cam disposed within the circular aperture. The second shaft includes a second cam disposed within the ovular aperture. The first cam and the second cam are configured to move the blade assembly in a circular motion.

This application claims the benefit of U.S. provisional application No. 63/580,037, filed Sep. 1, 2023, which is incorporated herein by reference in its entirety.

### TECHNICAL FIELD

This disclosure relates to ceramic matrix composite (CMC) parts and, in particular, to machining ceramic matrix composite parts.

### BACKGROUND

Present machining systems and methods for ceramic matrix composite parts suffer from a variety of drawbacks, limitations, and disadvantages. Accordingly, there is a need for inventive systems, methods, components, and apparatuses described herein.

### SUMMARY

Systems and methods described herein enable machining of difficult features in a ceramic matrix composite (CMC) part. For example, machining systems described herein may include a blade configured to move in a circular direction while maintaining a cutting edge of the blade parallel to the CMC part.

In some examples, a machining system includes a blade assembly, a first shaft configured to rotate in a first direction, and a second shaft configured to rotate in a second direction that is an opposite direction of the first direction. The blade assembly includes a blade, a circular aperture, and an ovular aperture. The first shaft includes a first cam disposed within the circular aperture. The second shaft includes a second cam disposed within the ovular aperture. The first cam and the second cam are configured to move the blade assembly in a circular motion.

In some examples, the system includes a ceramic matrix composite (CMC) part and/or a motor. The motor is configured to cause the first cam and second cam to rotate. The first cam and the second cam are configured to move the blade assembly in a circular motion and cut a slot in the CMC part.

In some examples, a method of machining a slot in a ceramic matrix composite part includes rotating a first cam in a first direction and rotating a second cam in a second direction that is opposite the first direction. The first cam is disposed within a circular aperture of a blade assembly. The second cam is disposed within an ovular aperture of the blade assembly. The method includes repeatedly moving a flat blade of the blade assembly in a circular motion as a result of movement of the first cam and the second cam to machine the slot in the CMC part.

The details of one or more examples of the disclosure are set forth in the accompanying drawings and the description below. Other features, objects, and advantages will be apparent from the description and drawings, and from the claims.

### BRIEF DESCRIPTION OF DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates an example of a machining system and CMC part.

FIG. 2 illustrates another example of a machining system and CMC part.

FIG. 3 illustrates another example of a machining system and CMC part.

FIG. 4 illustrates another example of a machining system and CMC part.

FIG. 5 illustrates another example of a machining system and CMC part.

FIG. 6 illustrates another example of a machining system and CMC part.

FIG. 7 illustrates another example of a machining system and CMC part.

FIG. 8 illustrates another example of a machining system and CMC part.

FIG. 9 illustrates an example of a CMC part.

FIG. 10 illustrates another example of a CMC part.

FIG. 11 illustrates another example of a CMC part and blade of a machining system.

FIG. 12 illustrates a flow diagram of an example of the logic of a control unit.

### DETAILED DESCRIPTION

Systems and methods described herein enable machining of difficult features in a ceramic matrix composite (CMC) part, such as a slot with a relatively high aspect ratio—or a very thin, deep slot—that would otherwise be difficult to machine.

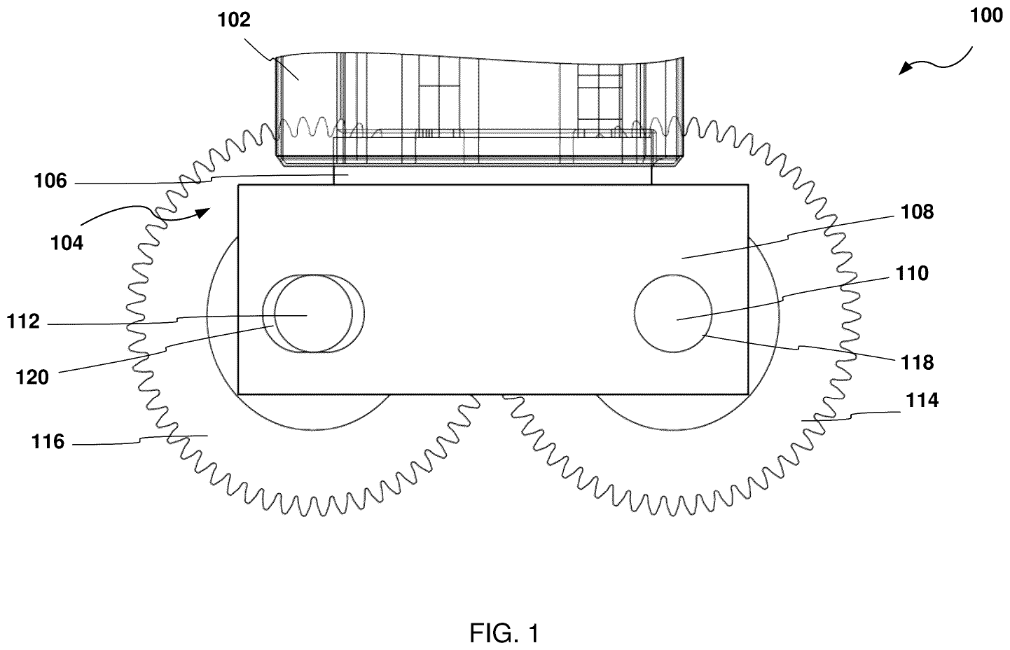

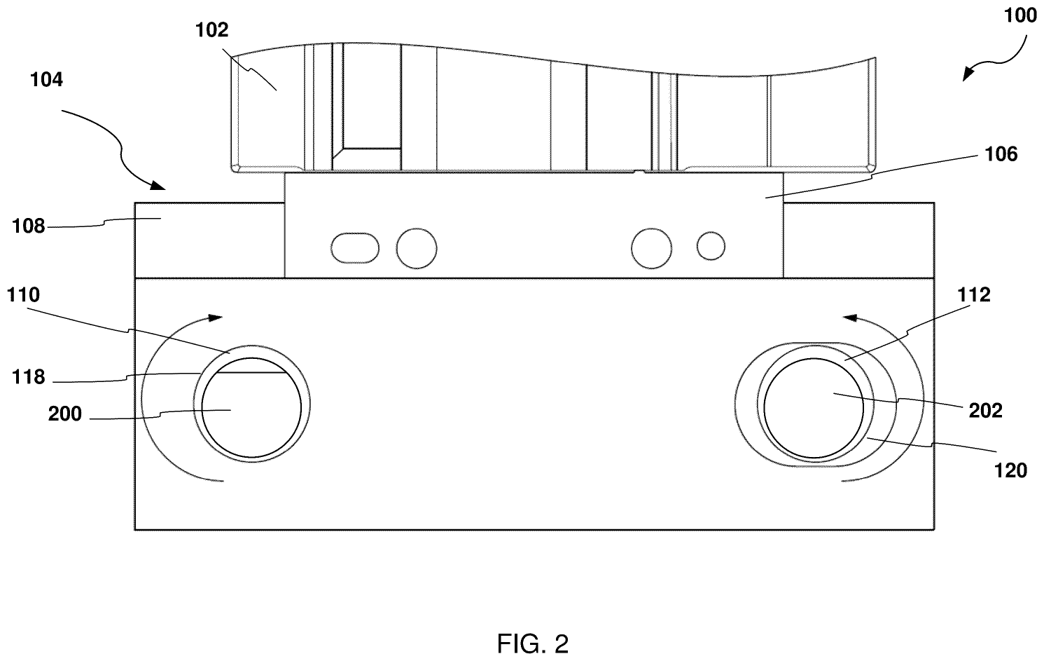

FIG. 1 illustrates an example of a machining system 100 and a ceramic matrix composite (CMC) part 102. Machining system 100 includes a blade assembly 104 including a blade 106 and a blade mount 108, a first cam 110 disposed on a first shaft 200 (first shaft 200 not visible in FIG. 1 as it is directly below first cam 110 from the view in FIG. 1, but is visible in FIG. 2), a second cam 112 disposed on a second shaft 202 (second shaft 202 not visible in FIG. 1 as it is directly below second cam 112 from the view in FIG. 1, but is visible in FIG. 2), a first gear 114, and a second gear 116. Blade mount 108 may include a first aperture 118 and a second aperture 120.

CMC part 102 may be any ceramic matrix composite part formed, by example, through a process including slurry and/or melt infiltration. CMC part 102 may be formed, for example, from a fiber preform and/or fiber tows. CMC part 102 may be any particular or specific part or component made through a CMC process. CMC part 102 may be a CMC component of a gas turbine engine, for example, a seal segment of a gas turbine engine.

Blade 106 may be any blade or component capable of machining a feature in the CMC part 102. In some examples, blade 106 may be a wide, thin blade capable of machining a slot in CMC part 102. Blade 106 may have, for example, a length of 10 millimeters (mm) to 150 mm, a depth of 3 mm to 6 mm, and a width of 0.8 mm to 2 mm. For example, the blade may have a dimension of 1 mm, with an aspect ratio of 100:1, capable of machining a seal slot in a seal segment component of a gas turbine engine. Blade 106 may comprise a diamond material, for example, a bonded or plated diamond material. Blade 106 may be a flat blade, in which a cutting edge of blade 106 is substantially flat.

Blade mount 108 may be any component capable of holding blade 106 and/or coupling blade 106 to first and second cams 110, 112. For example, blade mount 108 may be shaped, with a slot at one end into which blade 106 may fit and be mounted. Blade mount 108 may be comprised of steel or aluminum. Blade 106 may be mounted or secured within blade mount 108 by means of a screwed and doweled setup. Blade mount 108 may include first aperture 118 and second aperture 120. First and second apertures 118, 120 may extend all the way through blade mount 108 such that first and second cams 110, 112, respectively, may extend through apertures 118, 120, and through blade mount 108.

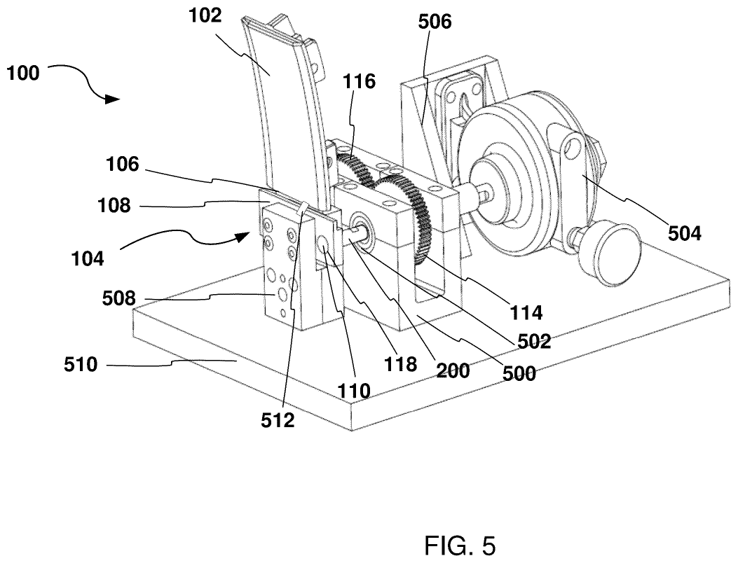

Blade 106 may comprise, for example, any kind of machinable metal, such as steel or aluminum. Blade 106 may be screwed and doweled to blade mount 108. Blade mount 108 may reciprocate between two sandwiched plates (shown in FIG. 5 as a blade mount housing 508). These plates may be the same material as blade mount 108 but may have a low friction interface to blade mount 108 itself. For example, blade mount 108 and/or plates may comprise Teflon® or PTFE.

First aperture 118 may be any shape such that rotation of first cam 110 within first aperture 118 causes movement of blade mount 108. First aperture 118 may be, for example, circular in shape such that a cross section of first aperture 118 is a circle. First aperture 118 may have a cross-sectional diameter that is larger than a cross-sectional diameter of first cam 110. For example, first aperture 118 may have a cross-sectional diameter of 5 mm to 30 mm. Additionally or alternatively, second aperture 120 may be any shape such that rotation of second cam 112 within second aperture 120 causes movement of blade mount 108. Second aperture 120 may be, for example, elongated in shape such that a cross section of second aperture 120 is ovular or elliptical. Second aperture 120 may have a cross-sectional area that is larger than a cross-sectional area of first cam 110. Cams 110, 112 may, for example, have respective diameters between 5 mm and 30 mm. Apertures 118, 120 may have respective diameters based on the size of their respective cams to allow cams 110, 112 to move, while constrain the motion of apertures 118, 120 accurately relative to the cams.

First cam 110 and second cam 112 may be disposed at the end of first and second shafts 200, 202, respectively. First and second cams 110, 112 may be disposed within first and second apertures 118, 120, respectively. First and second cams 110, 112 may have a length that is longer than a thickness of blade mount 108 such that cams 110, 112 extend all the way though blade mount 108 and past the outer surfaces of blade mount 108. Cams 110, 112 may be any shape to cause movement of the blade mount 108 when cams 110, 112 rotate within apertures 118, 120. For example, cams 110, 112 may be circular in shape such that they have a circular cross-section. Cams 110, 112 may have a cross-sectional diameter and/or area that is smaller than a cross-sectional diameter or area of apertures 118, 120 such that apertures 118, 120 and/or blade mount move relative to cams 110, 112 when cams 110,112 rotate within apertures 118, 120. Cams 110, 112 may be the same shape and/or size as each other, or cams 110, 112 may vary in shape and/or size from each other.

First cam 110 may be disposed on the end of first shaft 200 (shown in FIG. 2), and an end of first shaft 200 opposite first cam 110 may be disposed within first gear 114. Additionally or alternatively, second cam 112 may be disposed on the end of second shaft 202 (shown in FIG. 2), and an end of second shaft 202 opposite second cam 112 may be disposed within second gear 116. First and second gears 114, 116 may mesh together such that rotation of one of the gears may cause rotation of the other gear. Gears 114, 116 may be meshed together such that the gears counter rotate with respect to one another. For example, rotation of first gear 114 in the clockwise direction may cause rotation of second gear 116 in the counter clockwise direction. Alternatively, rotation of first gear 114 in the counterclockwise direction may cause rotation of second gear 116 in the clockwise direction.

During operation, gears 114, 116 may rotate, causing rotation of shafts 200, 202. Rotation of shafts 200, 202 may cause cams 110, 112 to rotate. For example, first gear 114, first shaft 200, and first cam 110 may rotate counter clockwise as viewed in FIG. 1, or towards second gear 116. Additionally, second gear 116, second shaft 202, and second cam 112 may rotate clockwise as viewed in FIG. 1, or towards the first gear 114. Rotation of cams 110, 112 within apertures 118, 120 may cause movement of blade mount 108 in a circular motion.

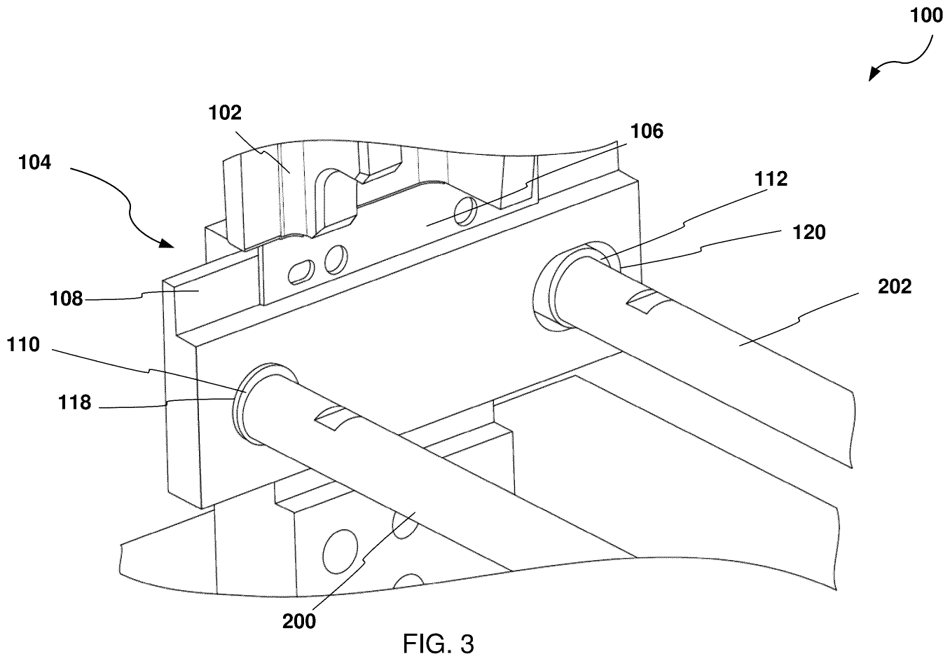

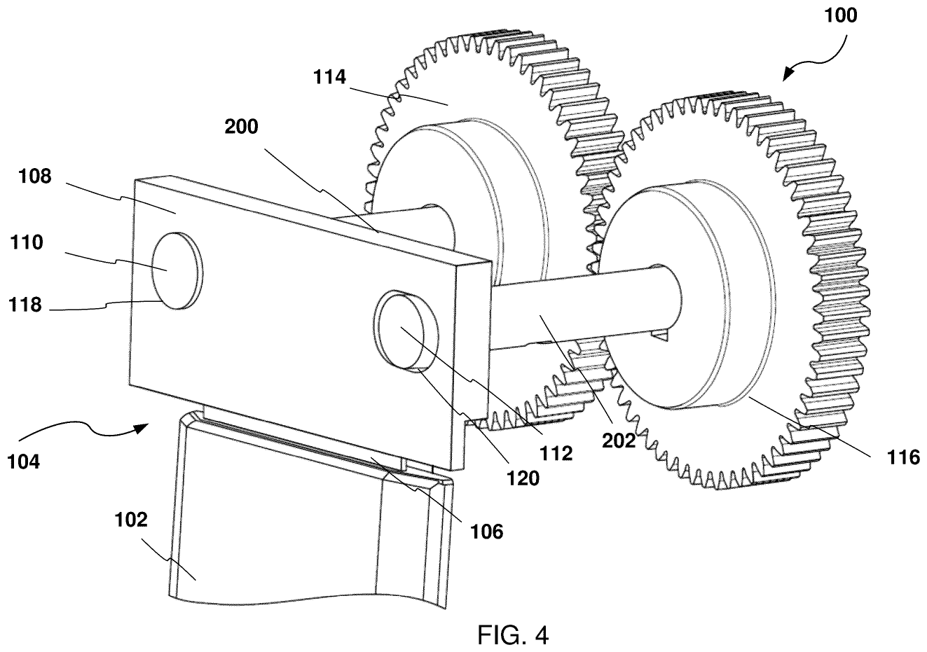

FIGS. 2-4 illustrate another view of machining system 100. In particular, FIGS. 2-4 illustrate a view of machining system 100 from the opposite direction of FIG. 1 and with gears 114, 116 removed, such that shafts 200, 202 are now visible in front of cams 110, 112.

As shown in FIG. 2, first cam 110 and second cam 112 may not be co-axial with first shaft 200 and second shaft 202, respectively. For example, a center point and/or a central axis of first and second cams 110, 112 may be offset from and/or not coaxial a center point and/or central axis of first and second shafts 200, 202, respectively, such that rotation of shafts 200, 202 in the causes a circular motion of blade mount 108 as cams 110, 112 rotate within apertures 118, 120.

FIG. 5 illustrates machining system 100 and CMC part 102, machining system 100 further including a gearing housing 500, bearings 502, a motor 504, a motor housing 506, a blade mount housing 508, a platform 510, and a coolant conduit 512. Blade mount housing 508, motor housing 506, and gearing housing 500 may be mounted to platform 510, which may simply be the floor or some other stable, secure surface.

Gear housing 500 may include bearings 502 and may house gears 114, 116. For example, gears 114, 116 may be mounted within gear housing 500 via shafts 200, 202. Bearings 502 may be mounted within the walls of gear housing 500 and shafts 200, 202 may extend through bearings 502 and the walls of the gear housing such that gear housing 500 supports shafts 200, 202 and gears 114, 116.

Motor 504 may be and device or component capable of driving or rotating the shafts 200, 202. For example, motor 504 may be an air or electric motor. Motor 504 may be mounted to motor housing 506, which may connect motor 504 to platform 510.

Blade mount housing 508 may constrain the motion of blade 106 to be perpendicular to the axis of rotation of cams 110, 112. Blade mount housing 508 may prevent blade mount 108 from moving up and down cams 110, 112, causing seal slot 900 to be machined in the right place. Blade mount housing 508 may, for example, include two plates, with blade mount 108 sandwiched between the two plates.

Coolant conduit 512 may comprise a conduit and/or a nozzle positioned to aim coolant into blade 106. Coolant conduit 512 may, for example, be positioned on the blade mount housing 508, blade 106, and/or any other part of machining system 100 to correctly direct the coolant to blade 106 and/or into seal slot 900 as CMC part 102 is being machined by blade 106. The coolant supplied by coolant conduit 512 may be an oil-based emulsion, for example, with a concentration ranging from 2 to 10% oil.

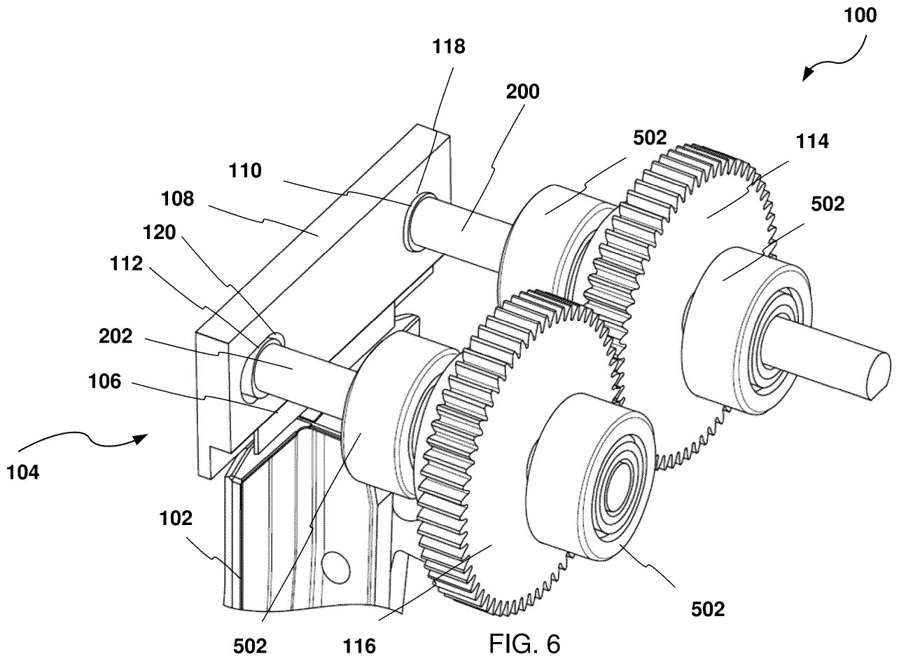

FIG. 6 illustrates another view of machining system 100 and CMC part 102, with gearing housing 500 removed to show a more detailed view of the coupling of shafts 200, 202, gears 114, 116, and bearings 502.

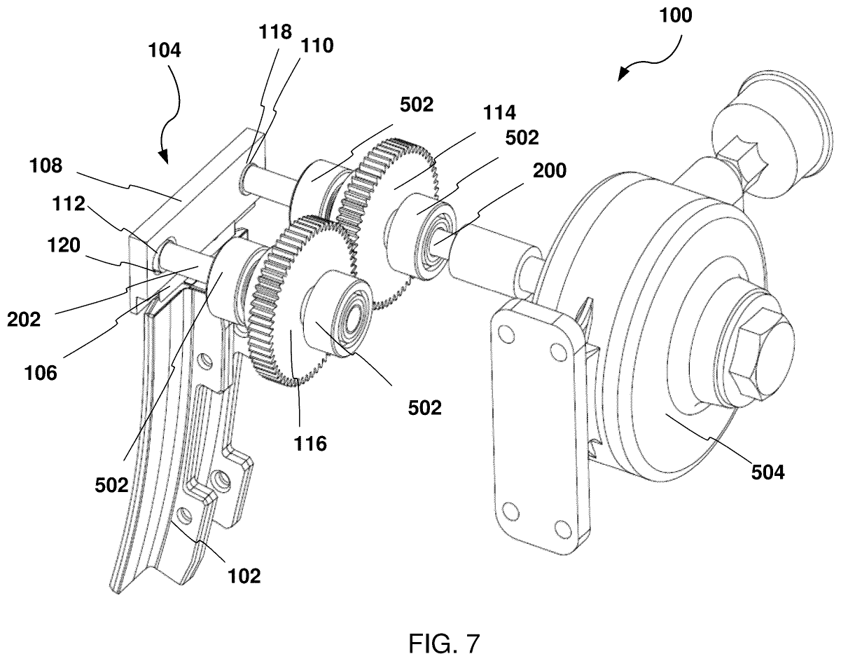

FIG. 7 illustrates another view of the machining system 100 and CMC part 102 as seen in FIG. 6 with motor 504. Motor 504 may be coupled to first shaft 200 such that motor 504 drives and/or causes first shaft 200, first gear 114, and first cam 110 to rotate. Additionally or alternatively, motor 504 may be coupled to second shaft 202. The rotation of first gear 114 from motor 504 may drive and/or cause second gear 116, second shaft 202, and second cam 112 to rotate.

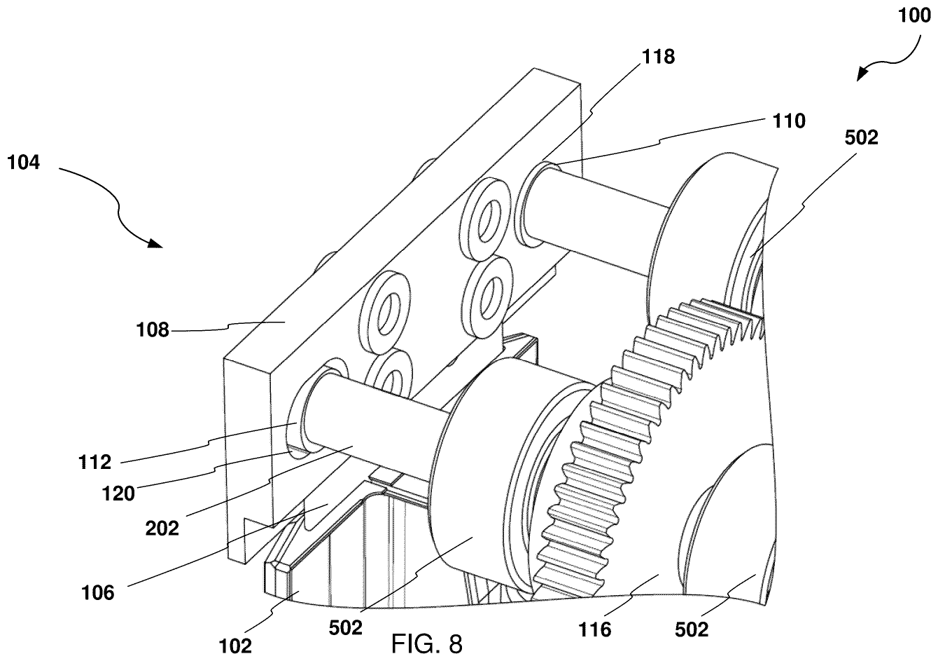

FIG. 8 illustrates another view of the machining system 100 and CMC part 102, with a close up of blade assembly 104, cams 110, 112, and apertures, 118, 120.

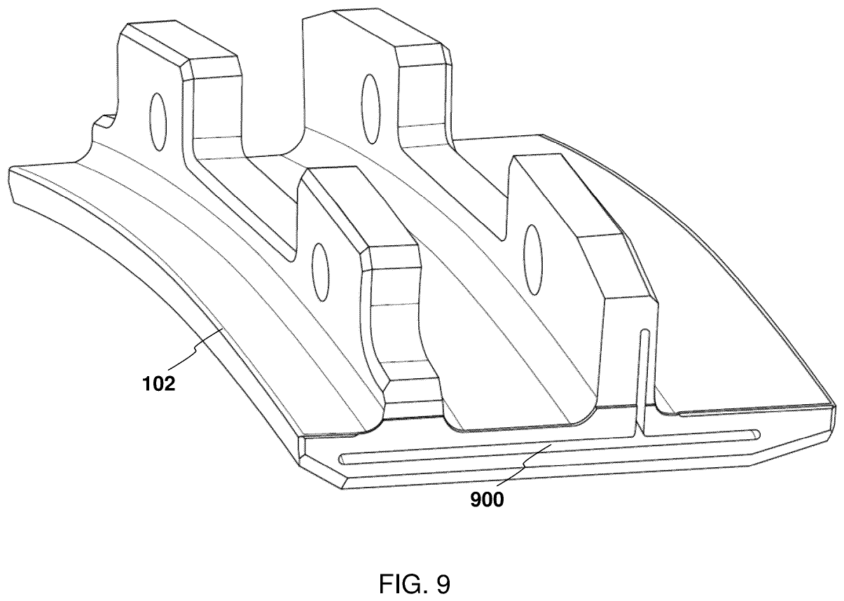

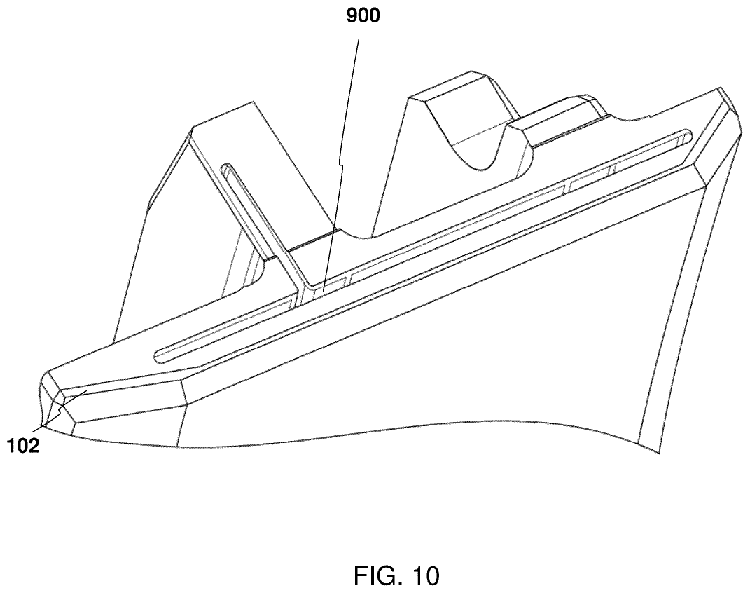

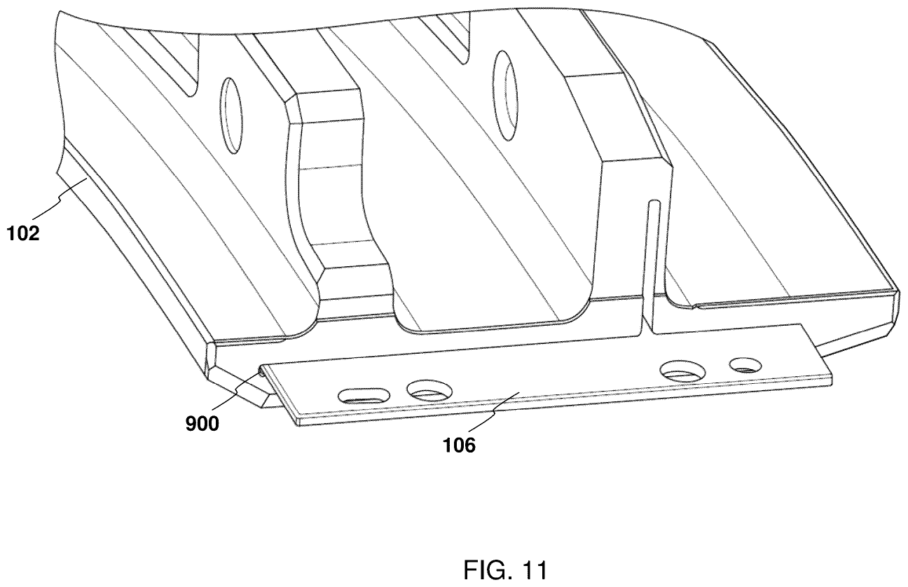

FIGS. 9-11 illustrate a detail view of CMC part 102 and seal slot 900 that is formed by blade 106 and machining system 100.

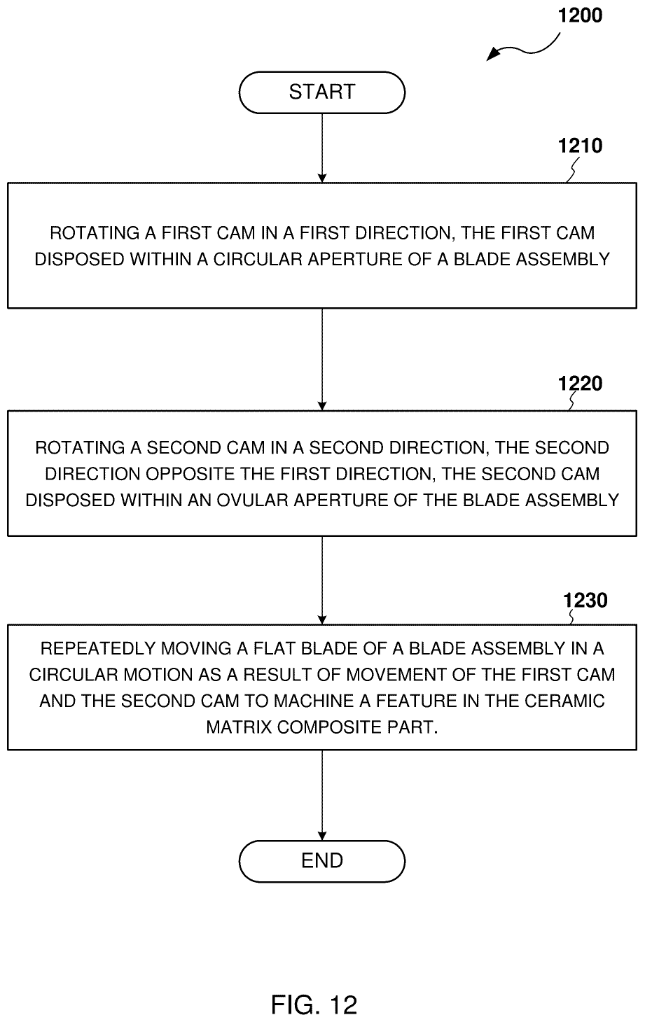

FIG. 12 illustrates a flow diagram of an example of a machining method 1200. The steps may include additional, different, or fewer operations than illustrated in FIG. 12. The steps may be executed in a different order than illustrated in FIG. 12.

Method 1200 may include rotating first cam 110 in a first direction (1210). First cam 110 may be disposed within circular first aperture 118 of blade assembly 104. Method 1200 may include rotating second cam 112 in a second direction (1220). The second direction may be opposite the first direction. Second cam 112 may be disposed within ovular second aperture 120 of blade assembly 104. Method 1200 may include repeatedly moving blade 106 of blade assembly 104 in a circular motion (1230) as a result of movement of first cam 110 and second cam 112 to machine a feature, such as seal slot 900, in CMC part 102.

The processes or cycle time for machining the feature, for example, seal slot 900, may take between 15 min to 60 min per slot.

Each component may include additional, different, or fewer components. Machining system 100 may be implemented with additional, different, or fewer components. The logic illustrated in the flow diagrams may include additional, different, or fewer operations than illustrated. The operations illustrated may be performed in an order different than illustrated.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various embodiments have been described, it will be apparent to those of ordinary skill in the art that many more embodiments and implementations are possible. Accordingly, the embodiments described herein are examples, not the only possible embodiments and implementations.

The subject-matter of the disclosure may also relate, among others, to the following aspects:

A first aspect relates to a machining system, the system comprising: a blade assembly including a blade, a circular aperture, and an ovular aperture; a first shaft configured to rotate in a first direction, the first shaft including a first cam disposed within the circular aperture; and a second shaft configured to rotate in a second direction, the second direction in an opposite direction from the first direction, the second shaft including a second cam disposed within the ovular aperture, the first cam and the second cam configured to move the blade assembly in a circular motion.

A second aspect relates to the system of aspect 1 further comprising a coolant to flow through a cut created by the blade and remove shavings created by operation of the machining system.

A third aspect relates to the system of any preceding aspect further comprising a motor to drive at least one of the first shaft or second shaft.

A fourth aspect relates to the system of any preceding aspect further comprising a first gear disposed on the first shaft and a second gear disposed on the second shaft, wherein the first gear drives the second gear or the second gear drives the first gear.

A fifth aspect relates to the system of any preceding aspect wherein the blade is configured to machine a slot in a ceramic matrix composite part.

A sixth aspect relates to the system of any preceding aspect wherein the blade is between 3-6 mm deep and 0.8-2 mm wide.

A seventh aspect relates to the system of any preceding aspect wherein the blade and machining system are configured to machine a slot with an aspect ratio of 100:1.

An eighth aspect relates to the system of any preceding aspect wherein the Blade comprises a bonded or plated diamond material.

A ninth aspect relates to a method of machining a slot in a ceramic matrix composite part, the method including: rotating a first cam in a first direction, the first cam disposed within a circular aperture of a blade assembly; rotating a second cam in a second direction, the second direction opposite the first direction, the second cam disposed within an ovular aperture of the blade assembly; repeatedly moving a flat blade of a blade assembly in a circular motion as a result of movement of the first cam and the second cam to machine the slot in the ceramic matrix composite part.

A tenth aspect relates to the method of aspect 9 further comprising moving the ceramic matrix composite part towards the blades to deepen the slot.

An eleventh aspect relates to the method of any preceding aspect further comprising flowing a coolant to flow through the slot created by the blade and removing shavings created by the blade from the slot with the coolant.

A twelfth aspect relates to the method of any preceding aspect further comprising driving at least one of a first shaft coupled to the first cam or a second shaft coupled to the second cam with a motor.

A thirteenth aspect relates to the method of any preceding aspect wherein a first gear is disposed on the first shaft and a second gear is disposed on the second shaft, the method further comprising driving the first gear with the second gear or the driving the second gear with the first gear.

A fourteenth aspect relates to the method of any preceding aspect further comprising machining a slot in a ceramic matrix composite part with an aspect ratio of 100:1.

A fifteenth aspect relates to the method of any preceding aspect further comprising machining first slot in a ceramic matrix composite part, repositioning the ceramic matrix composite part, and machining a second slot.

A sixteenth aspect relates to the method of any preceding aspect further comprising completing machining of the slot with a cycle time between 15 min to 60 min.

A seventeenth aspect relates to a machining system, the system comprising: a ceramic matrix composite part; a blade assembly including a blade, a circular aperture, and an ovular aperture; a first shaft configured to rotate in a first direction, the first shaft including a first cam disposed within the circular aperture; a second shaft configured to rotate in a second direction, the second direction in an opposite direction from the first direction, the second shaft including a second cam disposed within the ovular aperture; a motor configured to cause the first cam and second cam to rotate, the first cam and the second cam configured to move the blade assembly in a circular motion and cut a slot in the ceramic matrix composite part.

An eighteenth aspect relates to the system of any preceding aspect further comprising a first gear disposed on the first shaft and a second gear disposed on the second shaft, wherein the first gear drives the second gear or the second gear drives the first gear.

A nineteenth aspect relates to the system of any preceding aspect further comprising a coolant to flow through a cut created by the blade and remove shavings created by operation of the machining system.

A twentieth aspect relates to the system of any preceding aspect wherein the ceramic matrix composite part is a seal segment of a gas turbine engine.

In addition to the features mentioned in each of the independent aspects enumerated above, some examples may show, alone or in combination, the optional features mentioned in the dependent aspects and/or as disclosed in the description above and shown in the figures.

What is claimed is:

1. A machining system comprising:
a blade assembly including:
a blade,
a circular aperture, and
an ovular aperture;
a first shaft configured to rotate in a first direction, the first shaft including a first cam disposed within the circular aperture; and
a second shaft configured to rotate in a second direction, the second direction in an opposite direction from the first direction, the second shaft including a second cam disposed within the ovular aperture, the first cam and the second cam configured to move the blade assembly in a circular motion.

2. The machining system of claim 1, further comprising a coolant to flow through a cut created by the blade and remove shavings created by operation of the machining system.

3. The machining system of claim 1, further comprising a motor to drive at least one of the first shaft or the second shaft.

4. The machining system of claim 3, further comprising a first gear disposed on the first shaft and a second gear disposed on the second shaft, wherein the first gear drives the second gear or the second gear drives the first gear.

5. The machining system of claim 1, wherein the blade is configured to machine a slot in a ceramic matrix composite (CMC) part.

6. The machining system of claim 1, wherein the blade is from 3 millimeters (mm) to 6 mm deep and from 0.8 mm to 2 mm wide.

7. The machining system of claim 1, wherein the blade and machining system are configured to machine a slot with an aspect ratio of 100:1.

8. The machining system of claim 1, wherein the Blade comprises a bonded or plated diamond material.

9. A method of machining a slot in a ceramic matrix composite (CMC) part, the method including:
rotating a first cam in a first direction, the first cam disposed within a circular aperture of a blade assembly;
rotating a second cam in a second direction, the second direction opposite the first direction, the second cam disposed within an ovular aperture of the blade assembly; and
repeatedly moving a flat blade of the blade assembly in a circular motion as a result of movement of the first cam and the second cam to machine the slot in the CMC part.

10. The method of claim 9, further comprising moving the CMC part towards the blades to deepen the slot.

11. The method of claim 9, further comprising flowing a coolant to flow through the slot created by the blade and removing shavings created by the blade from the slot with the coolant.

12. The method of claim 9, further comprising driving at least one of a first shaft coupled to the first cam or a second shaft coupled to the second cam with a motor.

13. The method of claim 12, wherein a first gear is disposed on the first shaft and a second gear is disposed on the second shaft, the method further comprising driving the first gear with the second gear or the driving the second gear with the first gear.

14. The method of claim 9, further comprising machining a slot in the CMC part with an aspect ratio of 100:1.

15. The method of claim 9, further comprising machining first slot in the CMC part, repositioning the CMC part, and machining a second slot.

16. The method of claim 9, further comprising completing machining of the slot with a cycle time between 15 min to 60 min.

17. A machining system comprising:
a ceramic matrix composite (CMC) part;
a blade assembly including:
a blade,
a circular aperture, and
an ovular aperture;
a first shaft configured to rotate in a first direction, the first shaft including a first cam disposed within the circular aperture;
a second shaft configured to rotate in a second direction, the second direction in an opposite direction from the first direction, the second shaft including a second cam disposed within the ovular aperture; and
a motor configured to cause the first cam and second cam to rotate, the first cam and the second cam configured to move the blade assembly in a circular motion and cut a slot in the CMC part.

18. The system of claim 17, further comprising a first gear disposed on the first shaft and a second gear disposed on the second shaft, wherein the first gear drives the second gear or the second gear drives the first gear.

19. The system of claim 17, further comprising a coolant to flow through a cut created by the blade and remove shavings created by operation of the machining system.

20. The system of claim 17, wherein the CMC part is a seal segment of a gas turbine engine.
